(19) United States
(12) Patent Application Publication
(10) Pub. No.: US 2011/0214149 A1
(43) Pub. Date: Sep. 1, 2011

(54) TELEPHONE ORDERING OF TELEVISION SHOWS

(75) Inventor: DAVID N. SCHLACHT, Beverly Hills, CA (US)

(73) Assignee: The DIRECTV Group, Inc., El Segundo, CA (US)

(21) Appl. No.: 12/714,304

(22) Filed: Feb. 26, 2010

(51) Int. Cl. G06F 13/00; H04N 7/173

(52) U.S. Cl. 725/58; 725/99

(57) ABSTRACT

A method and system for controlling the digital consumption of media and information such as the recording of television programs, real world, or electronic merchandise from a plurality of a customer's Unique Identifiers (such as telephone numbers). The television programs are identified by specific identifiers, such as alpha-numeric indicia. Customers can register several Unique Identifier(s) with the service provider and can secure recording of specific programs from any of said registered Unique Identifier(s). Customers can also register Unique Identifier(s) such as the set top boxes at one or more locations and at the same time direct where the content will immediately or later be delivered, so that the recorded TV program can be accessed and viewed.

### TECHNICAL FIELD

The present invention relates to the recording of television programs and more particular to a new system and method for easier facilitation and control of the recording of television programs.

### BACKGROUND

The recording of programs broadcast on the various television, satellite and cable stations is known today. Persons who are unable to view a program when it is originally scheduled, or who are not at the location of their digital recorder or any video recording device including a network DVR, can utilize one of the known methods and systems for recording a program in order to view it later. It is also possible with some systems to automatically record all future programs which meet certain search criteria, such as having a certain name, feature certain actors, feature certain subjects (all horror names), etc.

Unfortunately, these systems are often difficult to use and require significant time and patience for the person setting up the recording. Many of these systems also require direct access to the television or cable system, either by direct manual operation, or from a remote handset in the immediate vicinity. Several systems exist today for remote recording using a computing device (PC or handheld), mobile phones using dedicated applications, or a browser on the device to setup the recording. These systems typically require the user to have a data plan for the device to access the remote recording service via broadband, or the cellular or WIFI network, and require the user to enter in personal user names and passwords with a telephone or qwerty keypad and therefore are difficult to navigate and use.

### SUMMARY OF THE INVENTION

The present invention provides a system and method of recording television programs. The television programs can be remotely scheduled or immediately recorded from a number of telephones and locations and by dialing only a dedicated telephone number, or by selecting a particular identifier.

For customers that have been enrolled with a specific television program service provider, all of the customers' Unique Identifier(s) can be registered. The Unique Identifiers(s) can be a main residence telephone number, a second home telephone number, a cell phone number, a business telephone number, etc. or any unique alpha numeric sequence or identifier that can be uniquely linked to a customer or member of a customers household/domain. These Unique Identifiers are stored in the service provider's Storage such as a Storage system or any electronic storage memory or disk and linked to that customer's name and account. A specific virtual telephone number could be assigned to the customer by the service provider in its Storage system under which the customer's Unique Identifier(s) and set top boxes could be assigned.

Special Unique Identifier(s) may also be established with respect to certain television programs or events, such as 1-800-ABCLost or 1-866-DTVLost. When the customer calls one of these Unique Identifier(s) from a registered telephone number or device, or sends an email, or text message to a “special number”, the next episode or viewing of that particular television show can be automatically recorded, or recording options for that particular show can be offered (e.g. past episodes, all future episodes, etc.).

For sporting events, the next game or all future games can be designated for recording, also by calling one telephone number (e.g. 1-800-SFGiants) and from any one of several registered telephones, or any electronic means from a registered phone, device or email account, or using any uniquely identifiable information associated with an individual or individual account or video recorder. For example, a text message from a registered phone or unique number registered to a device might also be used.

Television programs or events without special Unique Identifier(s) can be provided with coded identifiers, such as individual alpha-numeric identifiers. When a customer calls from a registered telephone number, that alpha-numeric identifier can be selected or entered and instructions provided for later reordering of that program or event.

The customers can also register all of their set top boxes in a single location or multiple locations, or a network recording device can be commanded to record the requested content, and then the user can specify which (or all) of the set top boxes or other recording devices should have access to the later recorded show or program. The Storage-system can be programmed to record programs on a certain set top box if the call is made from a certain telephone number.

The present invention itself, together with further features and attendant advantages, will be best understood by reference to the following detailed description, taken in conjunction with the accompanying drawings.

### BRIEF DESCRIPTION OF THE DRAWINGS

FIG. 1 is a schematic diagram of an embodiment of the present inventive system.

FIG. 2 is a flow chart illustrating an embodiment of the present invention.

FIG. 3 is a flow chart illustrating another embodiment of the present invention.

### DESCRIPTION OF THE PREFERRED EMBODIMENTS

The present invention relates in one aspect to the tying of television programs, merchandise, etc. to a plurality of telephone numbers or any Unique Identifier(s) of a customer in order to allow the customer easier access to schedule recording of programs or purchasing of merchandise. In this regard, the terms “television programs” and “Unique Identifier(s)” are not meant to be limiting, but are used simply for ease of describing the subject matter. In another aspect, special telephone numbers or Unique Identifiers are established for certain programs, or certain identifiers are established for certain programs. This also facilitates easier selection and recording of future television programs.

The items to be recorded can include shows or programs which are broadcast or originated by television studios or companies, cable companies, satellite companies and the like. They can also be the “On Demand” movies, TV shows or any digital content a user may want to remotely manage, such as a queue of movies or music video clips etc. The “shows or programs” can be TV shows, movies, sporting events, and all other programs which are received by a customer's set top box from any source. They can also be any kind of digital video content, digital audio or tickets in any digital form or real world equivalent such as ordering a DVD. In the case of video content, this can be individual shows or events, or a series of shows or events, such as all episodes of the “Sopranos”, “Sex In The City”, or “Lost”, etc. The shows or programs could also be an individual sporting event, or a series of sporting events, such as an individual Los Angeles Lakers basketball game, or all of the Los Angeles Laker games in a season or X games out of a package of Y where X is less than or equal to Y.

The shows and programs are recorded by the service provider on the customer's set top boxes and stored for later viewing by the customer, or any other digital storage device. The request also can be for digital content to be sent electronically, or physical content in the physical world, such as movie tickets, sports merchandise, etc. The content or recorded shows and programs then can be retrieved and viewed by the customer at his convenience in the future on one or more of the customer devices, or sent to a location designated by the customer. In the case of video recording, a set-top box provided by a cable, satellite or other service company, or a network based storage device, is electronically connected to the customer's television set and used to present the recorded show or program on the television set. The digital content could also be electronically transferred manually or automatically to any electronic device for viewing such as a PC, cell phone, PDA or even a memory stick or card.

One embodiment of the present invention relates to assigning a particular telephone number to a particular program, event, or series of programs (such as Lost, Desperate Housewives, etc.) that are aired weekly and attract audiences that watch them faithfully. For programs of this popularity, or certain sporting events (e.g. Super Bowl), special events, etc., individual Unique Identifier(s) can be assigned to them. In that manner, a customer calling from a registered telephone can dial that special telephone number which can automatically result in the next episode or viewing of that particular program to be recorded on the customer's set top box. The system may find the show on a particular linear TV channel, or arrange to record or transfer the show in several ways. For example, if the customers recording device is busy or not accessible, it may schedule a later recording of the same content if available, or offer alternate options if the content is available by a different station or possibly as a Pay Per View, or an a la carte offering. The customer may also be prompted to change his or her subscription or purchase options depending on the account details and where and when they want the content scheduled, recorded or delivered.

For example, the special telephone number for the television show “Lost” could be 1-800-DTV-LOST. When the customer calls that telephone number from one of the registered Unique Identifier(s), the television company would immediately know the identity of the program that is to be recorded. At this point, the customer could be asked one question, namely whether it is the next episode that should be recorded. If the customer indicates affirmatively, the call is terminated and the next episode is recorded. If the customer desires other recordings, like past episodes, or several future episodes, then other menus and options would be presented for the customer to select and choose.

Another example would be to allow all fans of a certain sport or sports team (baseball-White Sox) to dial a single telephone number and have all the events/games associated with that team's phone number either to be purchased, recorded, or both. This makes it easier for the customer as the customer does not need to know what time or network the show is on. Also, with some matters, like professional baseball, some games are presented on a local or national network, or regional or national network. With this system, the customer just dials a special number (e.g.: 1-800-WHITESOX) from a registered telephone and all the games of a season or all weekday or weekend games are automatically recorded. In addition, new fee based services, such as video highlights, statistics or merchandise related to the particular subject matter of interest can be offered to these customers.

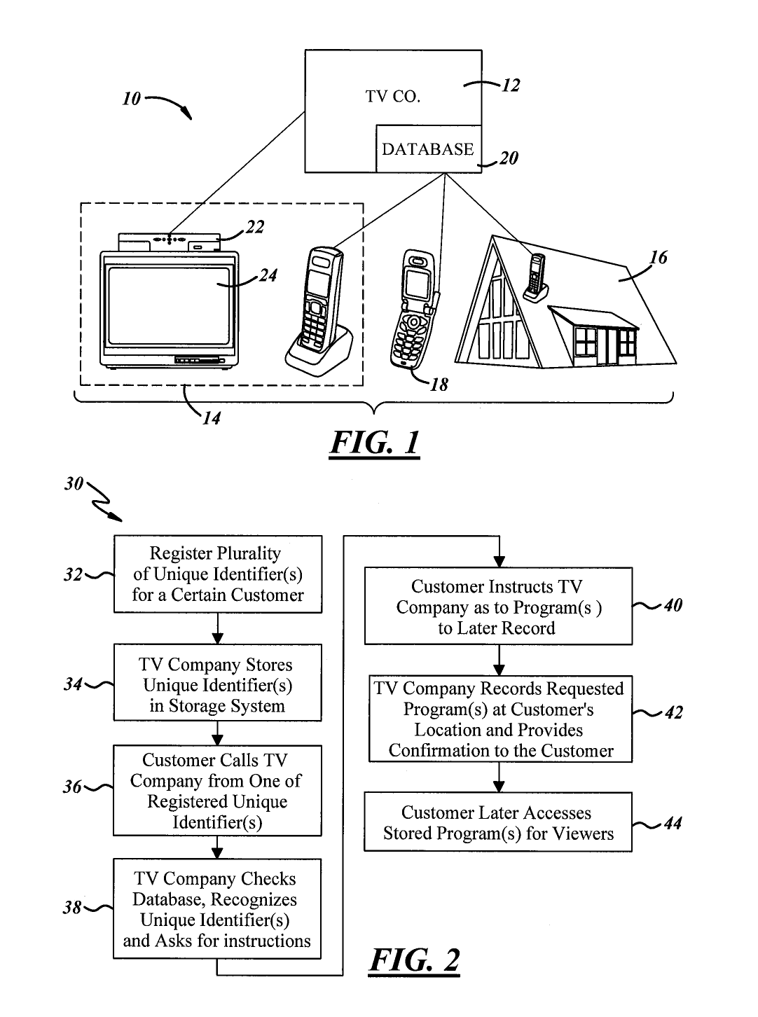

An embodiment of the present inventive system and method is depicted schematically in FIG. 1. The system 10 includes a television, broadcasting or satellite company 12 which is designated “TVCo.” The company 12 offers a wide range of shows and programs, merchandise and content (digital or physical) to a customer or subscriber for payment of a monthly fee or a la carte.

The signals sent to the customer's residence, business or other location can be sent by an orbiting satellite to a customer's satellite dish, and then sent electronically through wires or any electronic means to the set top box storage or ordering system 22 for viewing on a television. The content may also be emailed to an account, or sent to any device, or physically sent to a specified location 24. The signals could be sent from the service provider to the customer's set top box by any means including wired and wireless, but not limited to fiber optic cables, hardwire cables, cellular or wireless access.

In order to utilize the method and system, the custom registers with the company (e.g. “TVCo..”) all available Unique Identifier(s). These numbers could include the main residence 14, a second home, a vacation home 16 and a cell phone 18 (e.g. Blackberry or iPhone). All of these numbers are then stored in the TVCo. Storage system or other memory storage 20. Then, regardless of which of these Unique Identifier(s) that the customer utilizes, the system will recognize it as being associated to that customer and allow access to the goods (physical or electronic) or to record television programs for immediate or later viewing. In this manner, the customer can call in and secure recording of certain programs, shows, or series of programs, regardless of where the customer is when he thinks of recording it. The customer could be at his main residence, at his vacation home, out for dinner, in his car, etc. The system thus will prevent the customer from missing a chance to record and see a particular program regardless of where he is located—so long as he has access to one of the telephones or other uniquely identifiable devices, accounts (such as email or unique username or number), or other unique information registered with the TVCo's system. The customer also can order related merchandise (physical or electronic) for later viewing or consumption.

Upon receiving instructions and input from a customer through one of the customer's Unique Identifier(s) in this manner, the company (e.g. TVCo.) sends instructions to fulfill the customer's request or to a device, such as a set top box, to record the particular requested program or series of programs. The customer's set top box 22 then can be fulfilled immediately, or accessed for later viewing of the recorded program, series of programs, or requested digital content.

The actions by the customer in identifying the time, day, identity, etc. of the particular show or program that is to be recorded, and the location of the set top box where it is to be viewed by the customer, can be carried out automatically, or in a series of steps and menus by the customer on his telephone. First, for all of the shows or programs at the company (TVCo.) that have specially assigned Unique Identifier(s), that number can be called by the customer. TVCo's Storage system links the customer's telephone to the special telephone number which facilitates ease of recordings of that program. Other programs without special Unique Identifier(s) are identified by the company with a certain indicia. This could be, for example, an alpha-numeric identifier. Each show, program, series, movie, etc. is identified by its own separate identifier. The identifiers for the programs are made available to the customers of the service provider, such as, for example, sent to the customer by text, fax, or mail on a regular basis, or sent electronically through advertising and promotion by the TVCo., on the television set. The identifiers could also be advertised in public or private locations online, or in the physical world.

The identifier for the show could be suggestive or descriptive of the show or program in order to allow customers to find it more easily. For example, TV shows could have identities such as “Dirtyjobs”, “TVGolf”, etc.

The same special Unique Identifier(s) or other identifiers could be used by the company for all of its shows or programs, regardless of the identity of the customer or the number of customers who have asked to record them. This is because the customer's Unique Identifier(s) are registered and entered in the Storage system and are then specifically linked to the show or program, series of programs, or other digital content selected.

The customer could access the TVCo. Storage system in several ways so long as the customer's Unique Identifier(s) are registered and identified in the TVCo. Storage system. The customer could ask for recording of a future show or program by use of a computer or text message, and use one of the registered Unique Identifiers as the means to access the Storage system.

Once the customer is recognized by the TVCo. Storage system and if the recording of the selected show is not set up to be automatic, a series of screens or menus can be provided which will allow the customer to select the particular show and the date and time when it is being shown (and thus is to be recorded). The customer's set top boxes would also be registered with the company and there would be a menu screen which allows the customer to specify the specific set top box, device, location or address (real or electronic) in which the particular show, program or content in question is to be recorded or sent. The Unique Identifier(s) of the customer could be registered with TVCo. in a number of ways, such as through the internet, regular landline telephone, cell phone, TV menus, and the like.

After the selection of a particular show or program, or ordering of any content or goods, and taking steps to have it shipped, transmitted or recorded for later viewing—or consumption—the customer can confirm the instructions by calling a special number, or by sending a text message, email, etc., that uniquely confirms the customers identity. High value goods may require a password or higher level of security to protect the users account from fraudulent access. The company could answer the special number or confirmation by an IVR (Interactive Voice Response system), or any electronic or physical confirmation, such as a phone call or email, to confirm the customer's instructions. The company (TVCo.) also could automatically provide a voice, email or text confirmation message to the customer.

Concurrently with the confirmation, or later, the company could send text, email or voice message to the customer advising him of other matters that the company wants to promote, such as upcoming specials or sale of merchandise, particularly pertaining to the show or program (or its characters or actors) that is being recorded by the customer. Programming packages, such as premium channels, or HBO, or Showtime, could also be offered at that time if the customer had not already signed up for them.

If a call is received from a customer on a non-registered number, the customer can be directed to register the new number, such as by using voice prompts or directing the customer to use a PC, phone or interactive TV application to register the new number or identifier and to authenticate that number or unique information as belonging to the customer or family members. The customer could also be asked if he wanted to receive electronic or mail updates on any information, particular show, merchandise, scheduling information, upcoming movie or other content with a favorite actor, sports team, etc., and could select the means/media in which the updates would be provided (text message, cell phone, Blackberry, fax, mail, etc.).

Once the customer has called the TVCo. and provided the requisite information, the TVCo. Storage system will match the customer's registered Unique Identifier with the identifier or indicia for the show, program or other content. Then, from a linking or combination of these two numerical sets, one or more actions are set in motion by TVCo. in order to fulfill the customers request and make available the selected show or program for later viewing by the customer at a particular television or set top box or other location and/or at a certain time and date.

During registration, the customer could also link one of his Unique Identifiers to a particular device, address, account, set top box, or group of set top boxes in one or more of his locations. The Storage system would then automatically record the show or program and have it available for later viewing at that particular set top box or group of set top boxes.

FIG. 2 is a flow chart setting forth an inventive method 30 in accordance with an embodiment of the invention. The customer is a person(s), including members of a family or household who share one or more accounts, or a business or other entity who has subscribed/registered to the service provider for receipt of television programs or any other purpose, and who wishes to receive physical or electronic content and has had a set top box installed and electronically connected to a television set or any other means to obtain the content.

The customer takes steps 32 to register all Unique Identifier(s) that he desires to register with the service provider (e.g. TV Co.). The TV Co. stores all of the Unique Identifiers in its Storage system or other system and links them to the particular customer(s) and their account(s). This is step 34.

All of the customer's set top boxes, address, account information, etc. also should be registered in the Storage system. A virtual telephone number or other customer identifier could be set up in the Storage system for the particular customer. This virtual number or identifier could then be used by the customer to call in on, or to use in order to enter his instructions.

When the customer wants to order content or information or have any action done on their behalf by the service provider, such as record a scheduled show or program for viewing at a later time 36, or order merchandise or a ticket, he calls the TVCo. from one of the registered Unique Identifier(s). The TVCo. checks the Unique Identifier(s) with the information stored in its Storage system. This is step 38. If the Unique Identifier is one of the registered numbers, then a message or voice prompt is sent to the customer asking for instructions. Since the customer's name is also linked to the telephone number in the Storage system, the message could be personalized to refer specifically to the customers, such as: “Good Day, Mr. Jones, how can I help you.”

On the other hand, as stated above, if the program desired to be recorded by the customer is one of the most popular programs and has its own special identifier telephone number, the customer would simply call that number. TVCo. would then link that telephone number to the customer's registered telephone number and automatically set the customer's set top box to record the next episode or showing of that particular program.

If the program is not one of the most popular programs with a separate telephone number, or it is not just the next episode that is to be recorded, then the customer could be provided with a series of menu screens and/or drop-down lists until the specific subject or object of the customer's request is identified. At that point, as shown in step 40, the customer provides instructions to TVCo. as to the specific program or series of programs that are to be stored for later viewing.

The TVCo. acts on those instructions and stores the request and instructions in its Storage system. This is step 42. When the program is then broadcast by TVCo. at its regularly scheduled time and date, TVCo. sends instructions to the customer's set top box to record it. It then is available for viewing later by the customer at his convenience. TVCo. also can provide confirmation to the customer as to receipt of his instructions. This could be done by email, an internet account, fax, text message, regular mail, or the like, depending on the manner in which the customer desires to receive the confirmations.

Later, as shown in step 44, the customer accesses the stored program for his viewing pleasure.

As part of this method, the particular set top box or TV at which the customer desires the program/content to be presented is identified and sent as part of the instructions. The stored program is then sent by TVCo. to that set box/device for viewing. It is also possible for the customer to register a particular set top box at a particular location with a particular registered telephone number (such as a vacation home telephone number). In this manner, the program will be automatically recorded on that box at that location.

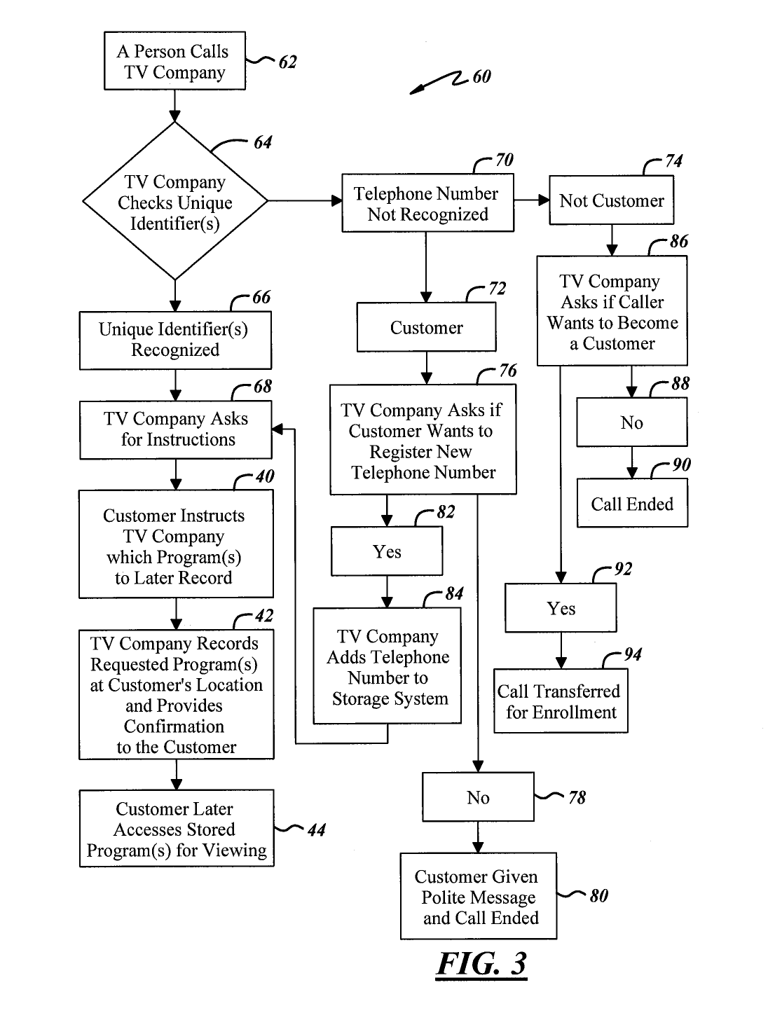

Another embodiment of the invention is depicted in flow chart form in FIG. 3. It is identified by the reference numeral 60. This method begins after customers have registered all of their Unique Identifier(s) with TVCo. and the numbers have been stored in the Storage system of TVCo. A person (customer or non-customer) calls TVCo. This is step 62. TVCo. then checks to see if the Unique Identifier/calling telephone number has been registered by one of its customers. This is step 64.

If the Unique Identifier number is registered and recognized, as indicated in step 66, then step 68 is followed. The TVCo. responds and asks for instructions or confirms the action in the case that only a single option exists. The method then progresses along the same path as set forth in FIG. 3. Steps 40, 42 and 44 are followed and the customer views the recorded program at his convenience.

If the telephone number is not recognized by TVCo., as shown in Step 70, then TVCo. asks the caller if he is a customer and, if so, to identify himself If the caller is a customer, then step 72 follows. If the caller is not a customer, then step 74 follows.

If the caller has been identified as a customer 72, then he is asked if he also wants to register the calling telephone number. This is step 76. If the customer declines 78, then he is politely asked 80 to call back from a registered telephone number.

If the customer wants the new Unique Identifier/telephone number to be registered 82, then TVCo. adds the new number to its Storage system. This is step 84. At this point, TVCo. then asks for instructions from the customer, as indicated in step 68, and the method proceeds through steps 40, 42, and 44.

If the call to TVCo. is not from a current customer of the service provider, as set forth in step 74, then TVCo. can inquire if the caller wants to be customer. This is step 86. If the caller says “no” 88 then the call is terminated 90. If the caller says “yes” 92, then the caller is transferred 94 to the appropriate group, web site, phone number or service division at TVCo. for enrollment.

Thus, the present invention allows customers to more easily consume content, set up recording of new or existing shows from any telephone (cell phone, land line, etc.). In the basic method, the customer can associate a particular Unique Identifier/telephone number or an easy to remember identifier with a show or video package. The invention also allows companies to collect Unique Identifiers such as telephone numbers, email addresses and/or set top box IDs of customers who like a particular show, sports team, actors or packages. Subject to privacy controls, these can be used to advertise future shows or similar shows, merchandise, provide news or offer other content or information tailored to the specific customer.

The invention also provides the service provider with an easy way to highlight new offerings and for customers to sample them or sign up to “receive the next episode” of that show or package.

The present invention uses the specific identifying indicia or alpha-numerical identifier for the show or program to perform operations that are not related to the phone number, but benefit from the pre-registered Unique Identifier(s) as a way to authenticate or identify the customer. In this manner, the customer does not have to log on or type in a password (except for some high value instances where the service provider wishes to prevent fraudulent activity). Simply calling from a registered telephone number or using another Unique Identifier allows all the rest to take place.

Although the invention has been described with respect to preferred embodiments, it is to be also understood that it is not to be so limited since changes and modifications can be made therein which are within the full scope of this invention as detailed by the following claims.

What is claimed is:

1. A method for ordering real or digital content, including recording television programs, for viewing or consumption comprising the steps of:
registering a plurality of Unique Identifiers, such as telephone numbers, pertaining to a specific customer(s);
storing said Unique Identifier(s) in a Storage system;
assigning identifying indicia to a piece of real or digital content such as a television program; and
matching one of said plurality of Unique Identifiers with said identifying indicia of at least one of said television programs.

2. The method as described in claim 1 further comprising the steps of:
receiving instructions from said specific customer as to viewing or consumption of said content, such as recording of said one of said television programs;
entering said instructions into said Storage system.

3. The method as described in claim 2 further comprising the steps of:
acting upon said instructions and delivering said content, such as recording of said one of said television programs.

4. The method as described in claim 2 further comprising the steps of:
registering a plurality of set top boxes or identifiers of the specific customer;
storing said set top box or other identifiers in said Storage system;
receiving instructions from the specific customer as to which specific location/device or set top box identifier should be used to record said content immediately or later, such as recording said one of said television programs.

5. The method as described in claim 4 further comprising the step of acting upon said instructions and recording of said one of said television programs.

6. The method as described in claim 2 further comprising the step of advising the specific customer of receipt of said instructions.

7. The method as described in claim 4 further comprising the step of advising said specific customer of receipt of said instructions.

8. The method as described in claim 1 wherein said identifying indicia is a Unique Identifier dedicated to one or more pieces of content or merchandise, such as a particular program.

9. The method as described in claim 1 wherein said identifying indicia is an alpha- numeric identifier or other unique identifier for a particular program.

10. A method for ordering content or recording television program, comprising the steps of:
registering at least one Unique Identifier of a customer;
storing said Unique Identifier in a Storage system;
assigning a dedicated Unique Identifier to at least one piece of content or merchandise information, such as television program; and
matching said Unique Identifier of a customer to said dedicated Unique Identifier of said content or merchandise, such as a television program.

11. The method as described in claim 10 wherein at least two Unique Identifier for the same customer are registered in said Storage system.

12. The method as described in claim 10 further comprising receiving instructions from said specific customer as to immediate or later consumption of goods, such as ordering said content or a recording of said one of said television programs; and entering said instructions into said Storage system.

13. The method as described in claim 12 further comprising acting upon said instructions and providing said content or scheduling recording of said content, such as said one of said television programs.

14. The method as described in claim 12 further comprising:
registering a plurality of Unique Identifier(s), such as set top boxes/identifiers of the specific customer;
storing said Unique Identifiers in said Storage system;
receiving instructions from the specific customer as to which specific Unique Identifier is to be used for the consumption or delivery of said content or merchandise and which should immediately or later receive and consumption of said content, merchandise, or recording of said one of said television programs.

15. The method as described in claim 14 further comprising acting upon said instructions and consuming or delivering said content or merchandise, such as a recording of said one of said television programs.

16. The method as described in claim 12 further comprising advising the specific customer of receipt of said instructions.
